(19) United States
(12) Patent Application Publication
(10) Pub. No.: US 2012/0033904 A1
(43) Pub. Date: Feb. 9, 2012

(54) HYDRODYNAMIC GAS FILM BEARING COOLING FLOW CONTROL SYSTEM

(75) Inventors: Nathan Gibson, Tempe, AZ (US); Don Takeuchi, Tempe, AZ (US); Walter Lee Meacham, Phoenix, AZ (US); James Knorr, Tempe, AZ (US)

(73) Assignee: HONEYWELL INTERNATIONAL INC., Morristown, NJ (US)

(21) Appl. No.: 12/851,347

(22) Filed: Aug. 5, 2010

(51) Int. Cl. F16C 32/06

(52) U.S. Cl. 384/100

(57) ABSTRACT

A hydrodynamic gas film bearing cooling gas control system includes a hydrodynamic gas film bearing, a supply conduit, and a flow control device. The supply conduit is in fluid communication with the hydrodynamic gas film bearing, is coupled to receive a flow of cooling gas from a cooling gas supply source, and is configured to supply the flow of cooling gas to the hydrodynamic gas film bearing. The flow control device is coupled to the supply conduit and is responsive to a physical characteristic of the cooling gas or ambient environment to move between at least two positions to thereby vary the flow of cooling gas, through the supply conduit, to the hydrodynamic gas film bearing.

### TECHNICAL FIELD

The present invention generally relates to hydrodynamic gas film bearings, and more particularly relates to a system for adaptively controlling cooling flow to hydrodynamic gas film bearings.

### BACKGROUND

Hydrodynamic gas film bearings may be used in various high-speed rotating machines. A hydrodynamic gas film bearing runs on a film of gas, which allows it to operate without oil. During operation, a hydrodynamic gas film bearing generates heat. To remove the generated heat, a flow of cooling gas is supplied to the hydrodynamic gas film bearing. The cooling gas flows into the hydrodynamic gas film bearing, absorbs the heat, and exits the hydrodynamic gas film bearing carrying away the heat. As may be appreciated, the cooling gas supply system is preferably designed to provide sufficient cooling gas to maintain metal temperatures within acceptable limits.

Cooling gas requirements for hydrodynamic gas film bearings can vary significantly with bearing load, with the rotational speed of the component that the hydrodynamic gas film bearing mounts, and with the pressure and temperature of the cooling gas. A typical cooling gas system for hydrodynamic gas film bearings is unregulated, meaning that it does not controllably adjust the flow of cooling for varying conditions. The cooling gas system is designed so that it meets the cooling requirements for the most limiting condition, but then flows more cooling gas than is required at all other design points. If the difference between the most limiting condition and the typical operating condition is large the excess cooling gas can have a noticeable effect on the efficiency of the device. In the context of a gas turbine engine environment, the cooling gas source is typically the compressor. Hence, oversupplying a hydrodynamic gas film bearing with cooling gas may increase overall engine fuel consumption.

Accordingly, it is desirable to provide a system that will control the flow of cooling gas to one or more hydrodynamic gas film bearings, and thus not oversupply the hydrodynamic gas film bearings with cooling gas. The present invention addresses at least this need.

### BRIEF SUMMARY

In one embodiment, and by way of example only, a hydrodynamic gas film bearing cooling gas control system includes a hydrodynamic gas film bearing, a supply conduit, and a flow control device. The supply conduit is in fluid communication with the hydrodynamic gas film bearing, is coupled to receive a flow of cooling gas from a cooling gas supply source, and is configured to supply the flow of cooling gas to the hydrodynamic gas film bearing. The flow control device is coupled to the supply conduit and is responsive to a physical characteristic of the cooling gas or ambient environment to move between at least two positions to thereby vary the flow of cooling gas, through the supply conduit, to the hydrodynamic gas film bearing. When the physical characteristic of the cooling gas is pressure, restriction of the flow of cooling gas is varied at least inversely with the cooling gas pressure.

In another exemplary embodiment, a hydrodynamic gas film bearing cooling gas control system includes a hydrodynamic gas film bearing, a first supply conduit, a first flow control device, a second supply conduit, and a second flow control device. The first supply conduit is in fluid communication with the hydrodynamic gas film bearing, is coupled to receive a flow of cooling gas from a cooling gas supply source, and is configured to supply the flow of cooling gas to the hydrodynamic gas film bearing. The first flow control device is coupled to the first supply conduit and is responsive to a physical characteristic of the cooling gas or ambient environment to move between at least two positions to thereby vary the flow of cooling gas, through the first supply conduit, to the hydrodynamic gas film bearing. The second supply conduit is in fluid communication with the hydrodynamic gas film bearing, is coupled to receive a flow of cooling gas from the cooling gas supply source, and is configured to supply the flow of cooling gas to the hydrodynamic gas film bearing. The second flow control device is coupled to the second supply conduit and is responsive to the physical characteristic of the cooling gas or ambient environment to move between at least two positions to thereby vary the flow of cooling gas, through the second supply conduit, to the hydrodynamic gas film bearing.

In still another exemplary embodiment, a hydrodynamic gas film bearing cooling gas control system includes a hydrodynamic gas film bearing, a supply conduit, a first flow control device, and a second flow control device. The supply conduit is in fluid communication with the hydrodynamic gas film bearing, is coupled to receive a flow of cooling gas from a cooling gas supply source, and is configured to supply the flow of cooling gas to the hydrodynamic gas film bearing. The first flow control device is coupled to the supply conduit and is responsive to a physical characteristic of the cooling gas or ambient environment to move between at least two positions to thereby vary the flow of cooling gas, through the supply conduit, to the hydrodynamic gas film bearing. The second flow control device is coupled to the supply conduit and is responsive to the physical characteristic of the cooling gas or ambient environment to move between at least two positions to thereby vary the flow of cooling gas, through the supply conduit, to the hydrodynamic gas film bearing.

In yet another exemplary embodiment, a hydrodynamic gas film bearing cooling gas control system includes a hydrodynamic gas film bearing, a supply conduit, a flow control device, a first flow restriction, and a second flow restriction. The supply conduit is in fluid communication with the hydrodynamic gas film bearing, is coupled to receive a flow of cooling gas from a cooling gas supply source, and is configured to supply the flow of cooling gas to the hydrodynamic gas film bearing. The flow control device is coupled to the supply conduit and responsive to a physical characteristic of the cooling gas or ambient environment to move between a first position and a second position. The first flow restriction is disposed between the flow control device and the supply conduit, and has a first cross sectional flow area. The second flow restriction is disposed between the flow control device and the supply conduit, and has a second cross sectional flow area that is greater than the first cross sectional flow area. The cooling gas flows through the first flow restriction when the flow control device is in the first position, and through the second flow restriction when the flow control device is in the second position.

Furthermore, other desirable features and characteristics of the hydrodynamic gas film bearing cooling gas control system will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 depicts a simplified schematic of an exemplary embodiment of gas turbine engine;

FIGS. 2-5 depict simplified schematic representations of various embodiments of a hydrodynamic gas film bearing cooling gas supply system that may be implemented in a machine, such as the gas turbine engine of FIG. 1, that includes one or more hydrodynamic gas film bearings; and

FIGS. 6-8 depict simplified schematics of exemplary alternative configurations of hydrodynamic gas film bearing cooling gas supply systems.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description. Thus, although the description is explicitly directed toward an embodiment that is implemented in a gas turbine engine, it should be appreciated that it can be implemented in various other types of rotating machines that may be known now or developed hereafter in the art.

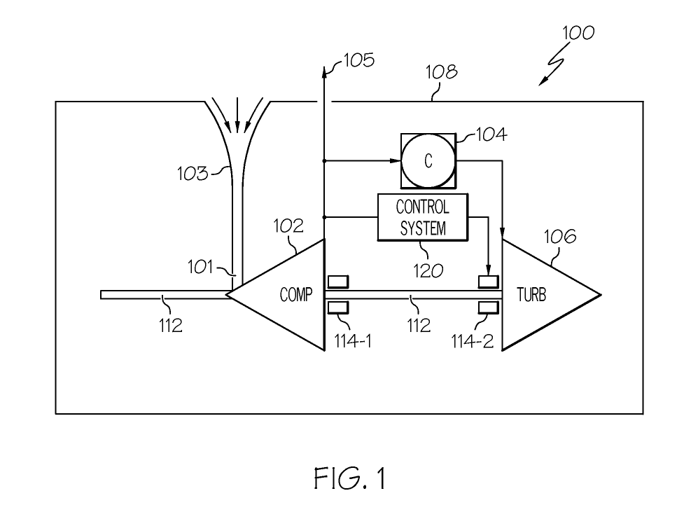

Turning now to FIG. 1, an embodiment of an exemplary gas turbine engine 100 is shown in simplified schematic form. The gas turbine engine 100 includes a compressor 102, a combustor 104, and a turbine 106, all preferably housed within an engine housing 108. During operation of the gas turbine engine 100, the compressor 102 draws ambient air into a compressor inlet 101, via a housing inlet duct 103 formed in the engine housing 108. The compressor 102 compresses the ambient air, and supplies a portion of the compressed air to the combustor 104, and may also supply compressed air to a bleed air port 105. The bleed air port 105, if included, may be used to supply compressed air to, for example, a non-illustrated environmental control system or other load. It will be appreciated that the compressor 102 may be any one of numerous types of compressors now known or developed in the future. For example, the compressor may be a single-stage or a multi-stage centrifugal compressor.

The combustor 104 receives the compressed air from the compressor 102, and also receives a flow of fuel from a non-illustrated fuel source. The fuel and compressed air are mixed within the combustor 104, and are ignited to produce relatively high-energy combustion gas. The combustor 104 may be implemented as any one of numerous types of combustors now known or developed in the future. Non-limiting examples of presently known combustors include various can-type combustors, various reverse-flow combustors, various through-flow combustors, and various slinger combustors.

No matter the particular type of combustor 104 that is used, the relatively high-energy combustion gas that is generated in the combustor 104 is supplied to the turbine 106. As the high-energy combustion gas expands through the turbine 106, it impinges on the turbine blades (not shown in FIG. 1), which causes the turbine 106 to rotate. It will be appreciated that the turbine 106 may be implemented using any one of numerous types of turbines now known or developed in the future including, for example, a vaned radial turbine, a vaneless radial turbine, and a vaned axial turbine. No matter the particular type of turbine that is used, the turbine 106 is mounted on a shaft 112, which is coupled to and drives the compressor 102. Moreover, depending on the particular end-use of the gas turbine engine 100, the turbine 106, via the shaft 112, may also be coupled to and drive a non-illustrated generator, a non-illustrated propeller, and/or one or more numerous other non-illustrated components.

The shaft 112 is rotationally mounted within the engine housing 108 via a plurality of bearings 114. In the depicted embodiment, only two bearings are depicted, a forward bearing 114-1 and an aft bearing 114-2. It will be appreciated, however, that the engine 100 could be implemented with more than this number of bearings 114. The type of bearings 114 that are used may also vary, but in the depicted embodiment at least one of the bearings 114, and specifically the aft bearing 114-2, is a hydrodynamic gas film bearing. The hydrodynamic gas film bearing 114-2 may be implemented using any one of numerous types of self-actuating hydrodynamic gas film bearing. Moreover, although the depicted hydrodynamic gas film bearings 114 provide radial support, it will be appreciated that the bearing(s) 114 can also be configured to provide axial (thrust) support or both radial and axial support. The hydrodynamic gas film bearing 114 can be a compliant hydrodynamic gas film bearing, one example of which is a foil bearing.

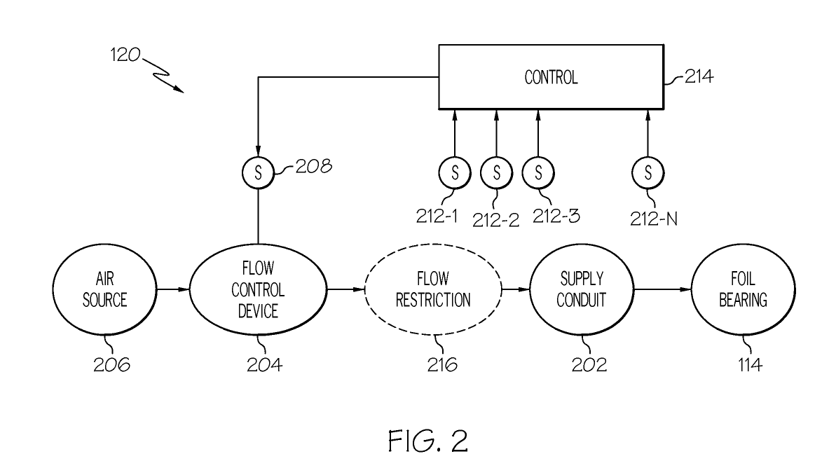

As is generally known, a hydrodynamic gas film bearing runs on a film of gas, and during operation generates heat. To remove the heat that is generated, a flow of cooling gas is supplied to the hydrodynamic gas film bearing. Thus, the gas turbine engine 100 also preferably includes a hydrodynamic gas film bearing cooling gas control system 120 to regulate the supply the flow of cooling gas to the hydrodynamic gas film bearing 114-2. The hydrodynamic gas film bearing cooling gas control system 120 is coupled to receive a flow of cooling gas from a pressurized source, and to controllably supply the cooling gas to the hydrodynamic gas film bearing 114-2. In the depicted embodiment, the pressurized gas source is the compressor 102, and hence the cooling gas is air. It will be appreciated, however, that the pressurized gas source may be any one of numerous other sources of pressurized cooling gas, either within or external to the gas turbine engine 100, and that the cooling gas may be any one of numerous suitable gaseous fluid media including, for example, air, helium, zeon, and nitrogen, just to name a few. It will additionally be appreciated that the hydrodynamic gas film bearing cooling gas control system 120 may be variously configured to implement its functionality. One particular configuration is schematically depicted in FIG. 2, and will now be described.

In the configuration depicted in FIG. 2, the hydrodynamic gas film bearing cooling gas control system 120 includes a supply conduit 202 and a flow control device 204. The supply conduit 202 is coupled to receive a flow of cooling gas from a cooling gas supply source 206. The supply conduit 202 is additionally in fluid communication with the hydrodynamic gas film bearing 114, and is thus configured to supply the flow of cooling gas to the hydrodynamic gas film bearing 114. As noted above, in the context of a gas turbine engine, such as the gas turbine engine 100 depicted in FIG. 1, the cooling gas supply source 206 is preferably the compressor 102 (or the above described bleed air system that is supplied by the compressor 102), though it could be any one of numerous other sources.

The flow control device 204 is coupled to, or otherwise mounted on, the supply conduit 202. The flow control device 204 is configured to be responsive to a physical characteristic of the cooling gas or the ambient environment (or both) to move between a plurality of positions, to thereby vary the flow of cooling gas, through the supply conduit 202, to the hydrodynamic gas film bearing 114. It will be appreciated that the physical characteristic(s) of the cooling gas or the ambient environment to which the flow control device 204 is responsive may vary, and may include one or more of cooling gas temperature, cooling gas pressure, ambient temperature, and ambient pressure, just to name a few. The flow control device 204 may additionally be configured to be responsive to one or more machine (e.g., gas turbine engine 100) conditions. Such machine conditions may also vary, and may include, for example, one or more of machine rotational speed, machine attitude, and machine component temperatures, just to name a few.

To carry out the above-described functionality, the flow control device 204 may be variously implemented and configured; however, in the embodiment depicted in FIG. 2, the flow control device 204 is implemented and configured as a multi-position valve. It will additionally be appreciated that the flow control device 204 may implemented using any one of numerous types of self-actuating flow control devices, or it may be controlled by a monitoring system. A self-actuating flow control device, as is generally known, includes a mechanical or other type of feature (e.g., a diaphragm, temperature responsive material, etc.) that automatically adjusts the position of the flow control device 204 in response to a change in a physical characteristic of the cooling gas, machine condition, and/or the ambient environment. If, however, the flow control device 204 is controlled by a monitoring system, the flow control device 204 will include a flow control device actuator 208, and the hydrodynamic gas film bearing cooling gas control system 120 will additionally include one or more sensors 212 and a control 214. The sensors 212 (e.g., 212-1, 212-2, 212-3, . . . 212-N) are each configured to sense a physical characteristic of the cooling gas and/or ambient environment, and to supply a sensor signal representative thereof to the control 214. The control 214 is in operable communication with the flow control device actuator 208 and the sensors 212. The control 214 receives the sensor signals from the sensors 212 and is configured, in response to the sensor signals, to supply flow control device commands to the flow control device actuator 208. The flow control device actuator 208, in response to the flow control device commands, positions the flow control device 204 to the commanded position. It will be appreciated that the number of sensors 212, and the physical phenomena that are sensed thereby, may vary.

In addition to variations in actuation configuration, the flow control device 204 may also be configured to implement various positional schemes. For example, when the flow control device 204 is implanted as a valve, it and various other components within the hydrodynamic gas film bearing cooling gas control system 120 (e.g., flow control device actuator 208 and control 214), if needed, may be configured and controlled to be positioned to a closed position, a full-open position, and any partial-open position between the closed and full-open position. With this type of configuration, the flow control device 204 may be used to continuously vary the flow of cooling to hydrodynamic gas film bearing 114. Alternatively, the flow control device 204 may be configured and controlled to move between just two positions, which may also vary. For example, the two positions may be the closed and full-open positions, the closed and a partially-open position, a partially-open and the full-open positions, or two different partially-open positions. With this type of configuration, the flow control device 204 may be used to vary the flow of cooling gas to the hydrodynamic gas film bearing 114 between two flow conditions—a high flow condition and a low flow condition.

As FIG. 2 additionally depicts, the hydrodynamic gas film bearing cooling gas control system 120 may also include a flow restriction 216. The flow restriction 216, if included, is configured to provide a step-down in cooling gas pressure, and may be positioned either downstream of the flow control device 204, as depicted in FIG. 2, or upstream of the flow control device 204. It will be appreciated that the flow restriction 216 may be variously implemented and configured, but in the depicted embodiment, the flow restriction is implemented and configured as an orifice having a cross sectional flow area that provides the step-down in cooling gas pressure. It will additionally be appreciated that if a step-down in pressure is not needed or if a suitable step down in pressure is provided by the flow control device 204 and/or the size and/or length of the supply conduit 202, then the flow restriction 216 may not be included. As such, the flow restriction 216 is depicted in FIG. 2 in phantom.

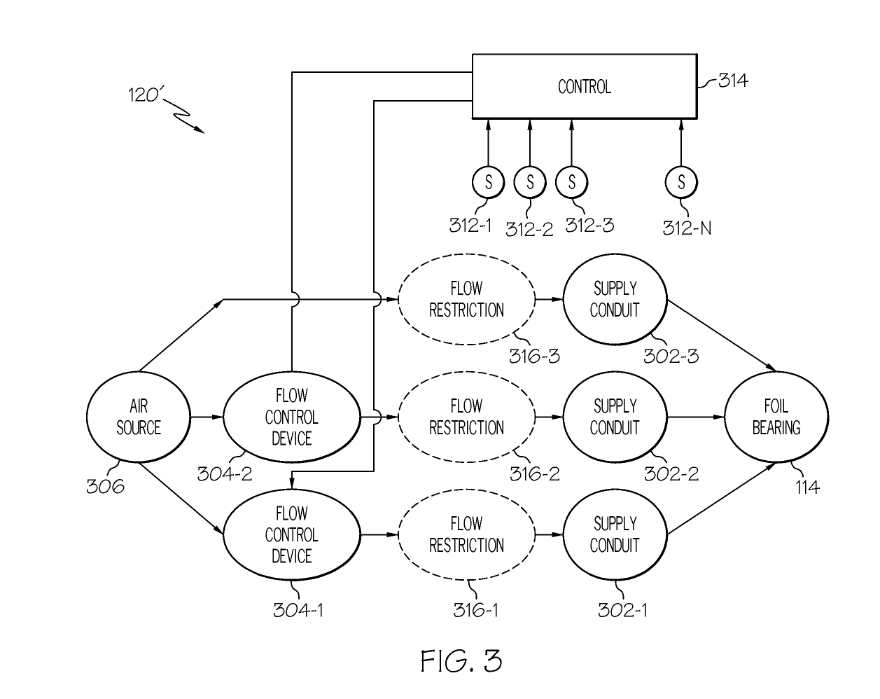

The hydrodynamic gas film bearing cooling gas control system 120 described above and depicted in FIG. 2 includes a single path and an adjustable flow control device 204 to vary cooling gas flow to the hydrodynamic gas film bearing 114. In alternative embodiments, the hydrodynamic gas film bearing cooling gas control system 120 is implemented using on/off flow control devices and multiple paths. Each of the alternative multi-path hydrodynamic gas film bearing cooling gas control systems 120, which will be described momentarily, includes multiple cooling gas supply paths between the cooling gas supply source and the hydrodynamic gas film bearing 114. One of the cooling gas supply paths is sufficient for the least limiting condition and does not include a flow control device. When the hydrodynamic gas film bearing 114 is operated under conditions that require more cooling gas flow than this one cooling gas path can provide, the flow control devices associated with the other cooling gas supply paths may be opened. Various embodiments of exemplary multi-path hydrodynamic gas film bearing cooling gas supply systems 120 are depicted in FIGS. 3-5, and will now be described.

Referring first to FIG. 3, the depicted multi-path hydrodynamic gas film bearing cooling gas control system 120′ includes a plurality of supply conduits 302 (e.g., 302-1, 302-2, 302-3) and a plurality of flow control devices 304 (e.g., 304-1, 304-2). The supply conduits 302, which include a first supply conduit 302-1, a second supply conduit 302-2, and a third supply conduit 302-3, are each coupled to receive a flow of cooling gas from a cooling gas supply source 306. The supply conduits 302 are each additionally in fluid communication with the hydrodynamic gas film bearing 114, and are thus configured to supply the flow of cooling gas to the hydrodynamic gas film bearing 114. As with the previous embodiment, the cooling gas supply source 306, in the context of a gas turbine engine, such as the gas turbine engine 100 depicted in FIG. 1, is preferably the compressor 102 (or the bleed air system that is supplied by the compressor 102), though it could be any one of numerous other sources.

The flow control devices 304, which include a first flow control device 304-1 and a second flow control device 304-2, are each coupled to, or otherwise mounted on, the first supply conduit 302-1 and the second supply conduit 302-2, respectively. The flow control devices 304 are each configured to be responsive to a physical characteristic of the cooling gas or the ambient environment (or both) to move between a plurality of positions, to thereby vary the flow of cooling gas, through the supply conduit 202, to the hydrodynamic gas film bearing 114. As before, it will be appreciated that the physical characteristic(s) of the cooling gas or the ambient environment to which the flow control devices 304 are responsive may vary, and may include one or more of cooling gas temperature, cooling gas pressure, ambient temperature, and ambient pressure, just to name a few. The flow control devices 304 may additionally be configured to be responsive to one or more machine (e.g., gas turbine engine 100) conditions. Such machine conditions may also vary, and may include, for example, one or more of machine rotational speed, machine attitude, and machine component temperature, just to name a few.

The flow control devices 304 may be configured and controlled to continuously vary the flow of cooling to hydrodynamic gas film bearing 114. Preferably, however, the flow control devices are configured and controlled to move between just two positions. The two positions may vary, and may include the closed and full-open positions, the closed and a partially-open position, a partially-open and the full-open positions, or two different partially-open positions. Preferably, however, the two positions are the closed and full-open positions.

As with the embodiment depicted in FIG. 2, the flow control devices 304 may be variously implemented and configured; however, in the embodiment depicted in FIG. 3, each flow control device 304 is implemented and configured as a multi-position valve. It will additionally be appreciated the flow control devices 304 may be implemented using any one of numerous types of self-actuating flow control devices, or the flow control devices 304 may be controlled by a monitoring system. If the flow control devices 304 are controlled by a monitoring system, each flow control device 304 will include a flow control device actuator (for clarity, not depicted in FIG. 3), and the hydrodynamic gas film bearing cooling gas control system 120′ will include one or more sensors 312 and a control 314. The one or more sensors 312 and control 314, if included, are preferably configured to function at least substantially identical to the sensors 212 and control 214 depicted in FIG. 2. As such, the descriptions thereof will not be repeated.

The depicted hydrodynamic gas film bearing cooling gas control system 120′ may also include one or more flow restrictions 316 (e.g., 316-1, 316-2, 316-3). The flow restrictions 316, if included, are associated, one each, with each of the supply conduits 302. It will be appreciated that the flow restrictions 316 may be variously implemented and configured, but in the depicted embodiment, each flow restriction 316 is implemented and configured as an orifice, each having a cross sectional flow area, which may or may not be equal, and that provides a step-down in cooling gas pressure. The flow restrictions 316 may additionally be variously positioned within the system 120′. It will be appreciated that if a step-down in pressure is not needed or if a suitable step down in pressure is provided by the flow control devices 304 and/or the size and/or length of the supply conduits 302, then one or more of the flow restrictions 316 may not be included. As such, the flow restrictions 316 are depicted in FIG. 3 in phantom.

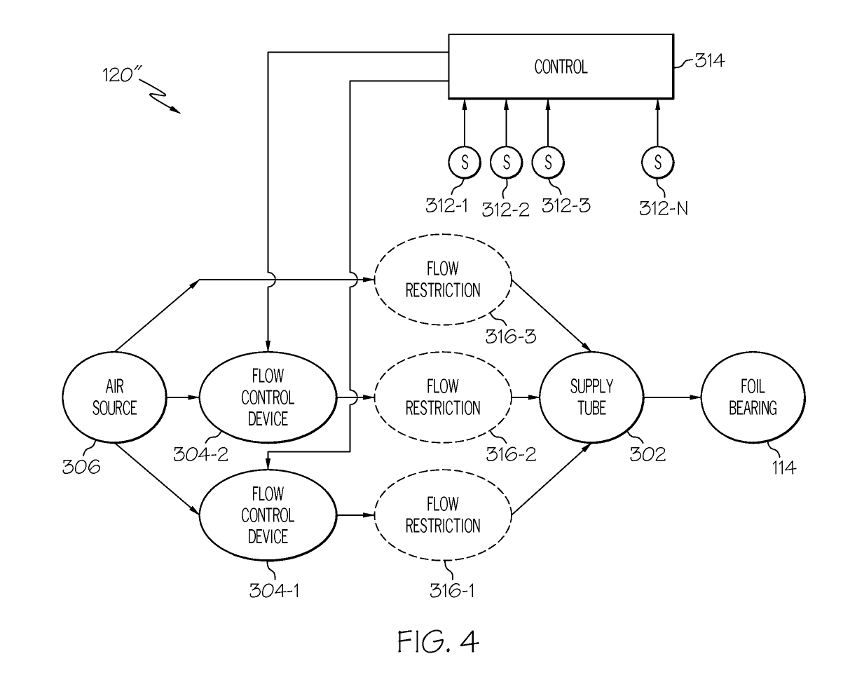

The multi-path hydrodynamic gas film bearing cooling gas control system 120″ depicted in FIG. 4 is substantially similar to the system 120′ depicted in FIG. 3. Thus, like reference numerals in FIGS. 3 and 4 refer to like components, and detailed descriptions of each component need not, and will not, be provided. As may be readily apparent, the difference between the two systems 120′, 120″ is that in the system 120″ depicted in FIG. 4, the hydrodynamic gas film bearing 114 is supplied with a flow of cooling via only one supply conduit 302, rather than via multiple independent supply conduits 302-1, 302-2, and 302-3.

The systems 120′, 120″ depicted in FIGS. 3 and 4 are each implemented with three cooling flow paths. It will be appreciated, however, that this number of cooling flow paths is merely exemplary, and that the systems 120′, 120″ may be implemented with more or less than this number of cooling flow paths. It will additionally be appreciated that the locations of the supply conduits 302, the flow control devices 304, and the flow restrictions 316 (if included) are merely exemplary, and may vary. Moreover, the set points at which the flow control devices 304 change position may vary, and the sizes of the supply conduits 302 and flow restrictions 316, both within and between systems, may also vary.

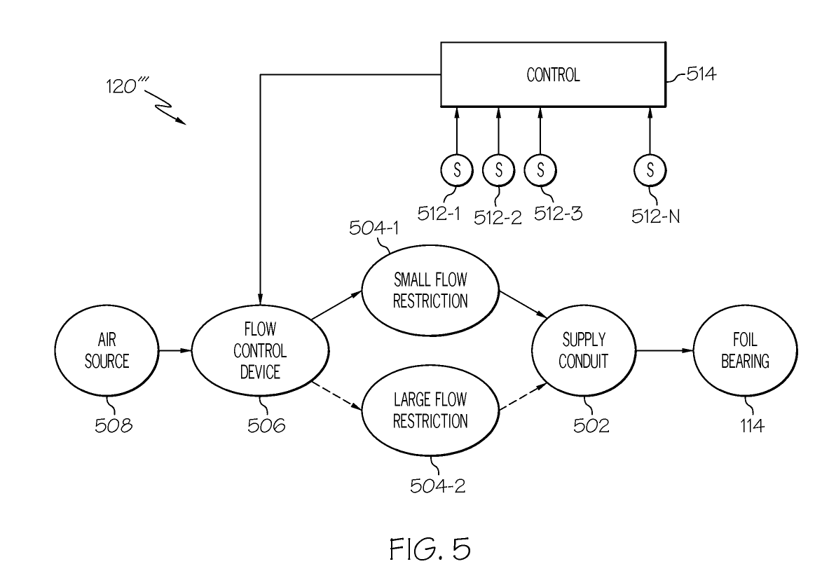

Turning now to FIG. 5, another multi-path hydrodynamic gas film bearing cooling gas control system 120′″ is depicted. This system 120′″ includes a supply conduit 502, a plurality of flow restrictions 504 (e.g., 504-1, 504-2), and a flow control device 506. The supply conduit 502 is coupled to receive a flow of cooling gas from a cooling gas supply source 508. The supply conduit 502 is additionally in fluid communication with the hydrodynamic gas film bearing 114, and is thus configured to supply the flow of cooling gas to the hydrodynamic gas film bearing 114. As with all of the previously-described embodiments, the cooling gas supply source 508, in the context of a gas turbine engine, such as the gas turbine engine 100 depicted in FIG. 1, is preferably the compressor 102 (or the bleed air system that is supplied by the compressor 102), though it could be any one of numerous other sources.

The flow restrictions 504, which include a first flow restriction 504-1 and a second flow restriction 504-2, are each disposed between the supply conduit 502 and the flow control device 506. The first flow restriction 504-1 has a first cross sectional flow area and the second flow restriction 504-2 has a second cross sectional flow area that is greater than the first cross sectional flow area. Hence, for the same set of conditions, cooling gas flow through the second flow restriction 504-2 will be greater than it would be through the first flow restriction 504-1. As with each of the previously described embodiments, tt will be appreciated that the flow restrictions 504 may be variously implemented and configured. In the depicted embodiment, however, each flow restriction 504 is implemented and configured as an orifice.

The flow control device 506 is disposed upstream of each of the flow restrictions 504, and is preferably implemented using a multi-position flow control device. The flow control device 506 is preferably configured to be responsive to a physical characteristic of the cooling gas or the ambient environment (or both) to move between a plurality of positions. In the depicted embodiment, the plurality of positions is two—a first position and a second position. When the flow control device 506 is in the first position, cooling gas from the cooling gas supply source 508 is directed through the flow control device 506 and into and through the first flow restriction 504-1. Conversely, when the flow control device 506 is in the second position, cooling gas from the cooling gas supply source 508 is directed through the flow control device 506 and into and through the second flow restriction 504-2. Thus, the flow of cooling gas, through the supply conduit 502, to the hydrodynamic gas film bearing 114 is varied by varying the position of the flow control device 506. In other embodiments, the flow control device 506 may be movable to more than two positions, and may include more than two flow restrictions, if needed or desired. With these other embodiments, the flow control device 506 may be positioned to simultaneously allow cooling gas flow through two or more flow restrictions 504.

As with all of the previously described embodiments, it will be appreciated that the physical characteristic(s) of the cooling gas or the ambient environment to which the flow control device 506 is responsive may vary, and may include one or more of cooling gas temperature, cooling gas pressure, ambient temperature, and ambient pressure, just to name a few. The flow control device 506 may additionally be configured to be responsive to one or more machine (e.g., gas turbine engine 100) conditions. Such machine conditions may also vary, and may include, for example, one or more of machine rotational speed, machine attitude, and machine component temperature, just to name a few. Moreover, the flow control device 506 may be variously implemented and configured. For example, the flow control device 506 may be implemented as a mechanical means, such as a sliding plate or similar device, that is configured to selectively cover and uncover (either partially or fully) the flow restriction(s) 504. In the embodiment depicted in FIG. 5, however, the flow control device 506 is implemented and configured as a multi-position switch valve.

The flow control device 506 may also be implemented using any one of numerous types of self-actuating flow control devices, or the flow control device 506 may be controlled by a monitoring system. If the flow control device 506 is controlled by a monitoring system, it will include a flow control device actuator (for clarity, not depicted in FIG. 5), and the hydrodynamic gas film bearing cooling gas control system 120′″ will include one or more sensors 512 and a control 514. The one or more sensors 512 and control 514, if included, are preferably configured to function at least substantially identical to the sensors 212 and control 214 depicted in FIG. 2. As such, the descriptions thereof will not be repeated.

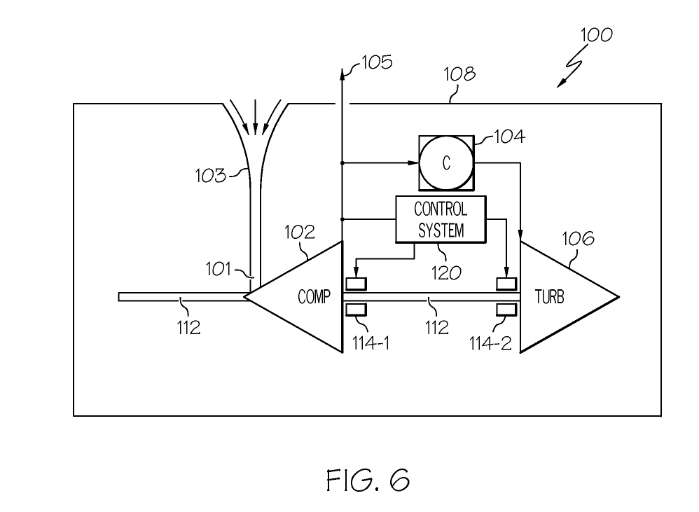

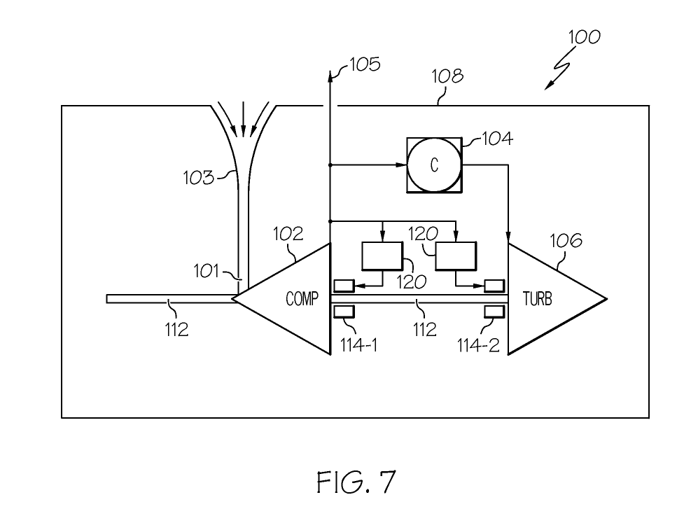

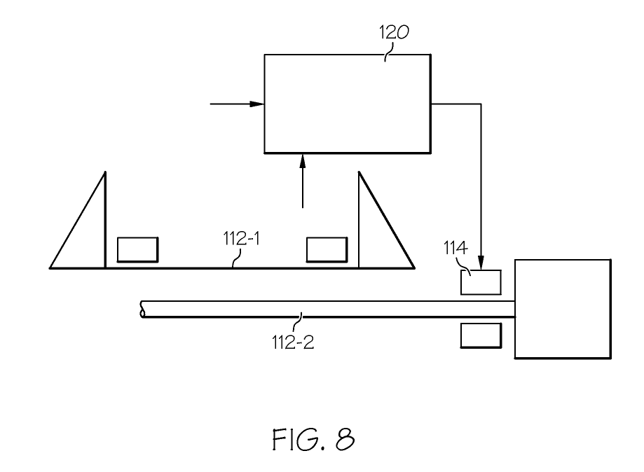

Although the hydrodynamic gas film bearing cooling gas control systems 120 described above are configured to adaptively control the supply of cooling gas to a single hydrodynamic gas film bearing 114, it will be appreciated that these are merely exemplary and that the hydrodynamic gas film bearing cooling gas control systems 120 may be configured to supply two or more hydrodynamic gas film bearings, if need or desired. Moreover, if a machine, such as the above-described gas turbine generator 100, includes two or more hydrodynamic gas film bearings 114, then two or more hydrodynamic gas film bearing cooling gas control systems 120, one associated with each of the bearings 114, could also be used. Further, some machines, such as multi-spool gas turbine engines, may include two or more shafts, each of which may be rotationally mounted using one or more hydrodynamic gas film bearings. In this latter case, the hydrodynamic gas film bearing cooling gas control systems 120 could be configured to measure conditions associated with one shaft, but control cooling gas flow to the hydrodynamic gas film bearing(s) on another shaft. An exemplary embodiment in which the hydrodynamic gas film bearing cooling gas control system 120 is configured to supply two hydrodynamic gas film bearings 114-1, 114-2 is depicted in FIG. 6. An exemplary embodiment in which two hydrodynamic gas film bearing cooling gas control systems 120 separately control cooling gas flow to two different hydrodynamic gas film bearings 114-1, 114-2 is depicted. An exemplary embodiment in which a hydrodynamic gas film bearing cooling gas control system 120 is configured to measure conditions associated with one shaft 112-1, and control cooling gas flow to the hydrodynamic gas film bearing(s) 114 on another shaft 112-2.

The various embodiments described herein are not limited to those explicitly depicted. Rather, some or all of the features associated with each of the depicted embodiments may be implemented with one or more of the other embodiments. For example, the embodiment depicted in FIG. 2 may be implemented to include one of more of the features of the embodiments depicted in FIGS. 3-5, and so on. Moreover, the embodiments depicted in FIGS. 2-4 may include any combination of additional controlled and uncontrolled paths, some, all, or none of which may include a flow restriction. The embodiment depicted in FIG. 5 may include more than two flow paths, each with variously sized flow restrictions. And, as was alluded to when describing the embodiment of FIG. 5, the flow control device of that embodiment may be configured to allow cooling gas flow through more than one flow restriction at a time, to thereby vary overall flow resistance. The embodiment depicted in FIG. 5 may also be implemented to include one or more of the features of the embodiments depicted in FIGS. 2-4 (e.g., one or more controlled and/or uncontrolled flow paths). Additionally, in each of the various embodiments the configuration of the supply conduit(s) may vary. For example, embodiments may be implemented with multiple supply conduits, a single supply conduit, multiple supply conduits in which one or more supply conduit has multiple cooling gas inputs.

The hydrodynamic gas film bearing cooling gas control systems described herein allows for optimized cooling gas flow to one or more hydrodynamic gas film bearings across a variety of operating conditions.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A hydrodynamic gas film bearing cooling gas control system, comprising:
a hydrodynamic gas film bearing;
a supply conduit in fluid communication with the hydrodynamic gas film bearing, the supply conduit coupled to receive a flow of cooling gas from a cooling gas supply source and configured to supply the flow of cooling gas to the hydrodynamic gas film bearing; and
a flow control device coupled to the supply conduit and responsive to a physical characteristic of the cooling gas or ambient environment to move between at least two positions to thereby vary the flow of cooling gas, through the supply conduit, to the hydrodynamic gas film bearing,
wherein, when the physical characteristic of the cooling gas is pressure, restriction of the flow of cooling gas is varied at least inversely with the cooling gas pressure.

2. The system of claim 1, further comprising:
a flow restriction disposed upstream of the hydrodynamic gas film bearing, the flow restriction having a cross sectional flow area,
wherein the cooling gas that flows through flow control device also flows through the flow restriction.

3. The system of claim 1, further comprising:
a second supply conduit in fluid communication with the hydrodynamic gas film bearing, the second supply conduit coupled to receive a flow of cooling gas from the cooling gas supply source and configured to supply the flow of cooling gas to the hydrodynamic gas film bearing.

4. The system of claim 3, further comprising:
a flow restriction disposed upstream of the hydrodynamic gas film bearing, the flow restriction having a cross sectional flow area;
wherein the cooling gas that flows in the second supply conduit also flows through the flow restriction.

5. The system of claim 1, further comprising:
a second supply conduit in fluid communication with the hydrodynamic gas film bearing, the second supply conduit coupled to receive a flow of cooling gas from the cooling gas supply source and configured to supply the flow of cooling gas to the hydrodynamic gas film bearing; and
a second flow control device coupled to the second supply conduit and responsive to the physical characteristic of the cooling gas to move between at least two positions to thereby vary the flow of cooling gas, through the second supply conduit, to the hydrodynamic gas film bearing.

6. The system of claim 5, further comprising:
a flow restriction disposed upstream of the hydrodynamic gas film bearing, the flow restriction having a cross sectional flow area;
wherein the cooling gas that flows through the second flow control device also flows through the flow restriction.

7. The system of claim 5, further comprising:
a third supply conduit in fluid communication with the hydrodynamic gas film bearing, the third supply conduit coupled to receive a flow of cooling gas from the cooling gas supply source and configured to supply the flow of cooling gas to the hydrodynamic gas film bearing.

8. The system of claim 7, further comprising:
a flow restriction disposed upstream of the hydrodynamic gas film bearing, the flow restriction having a cross sectional flow area,
wherein the cooling gas that flows through third supply conduit also flows through the flow restriction.

9. The system of claim 1, further comprising:
a second flow control device coupled to the supply conduit and responsive to the physical characteristic of the cooling gas or ambient environment to move between at least two positions to thereby vary the flow of cooling gas, through the supply conduit, to the hydrodynamic gas film bearing.

10. The system of claim 9, further comprising:
a flow restriction disposed upstream of the hydrodynamic gas film bearing, the flow restriction having a cross sectional flow area;
wherein the cooling gas that flows through the second flow control device also flows through the flow restriction.

11. The system of claim 1, further comprising:
a flow restriction disposed upstream of supply conduit, the flow restriction having a cross sectional flow area,
wherein cooling gas that flows through the flow restriction does so independent of the flow control device.

12. The system of claim 1, further comprising:
a first flow restriction disposed between the flow control device and the supply conduit, the first flow restriction having a first cross sectional flow area; and
a second flow restriction disposed between the flow control device and the supply conduit, the second flow restriction having a second cross sectional flow area, the second cross sectional flow area greater than the first,
wherein:
the flow control device moves between at least a first position and a second position,
the cooling gas flows through the first flow restriction at least when the flow control device is in the first position, and
the cooling gas flows through the second flow restriction at least when the flow control device is in the second position.

13. The system of claim 1, wherein the physical characteristic of the cooling gas or ambient environment includes one or more of pressure and temperature.

14. The system of claim 1, further comprising:
a sensor configured to sense the physical characteristic of the cooling gas or ambient environment and supply a sensor signal representative thereof; and
a control coupled to receive the sensor signal and in operable communication with the flow control device, the control configured, in response to the sensor signal, to supply flow control device commands to the flow control device,
wherein the flow control device is responsive to the flow control device commands to move between the at least two positions.

15. The system of claim 14, wherein the control is further configured to:
receive one or more additional signals representative of one or more machine conditions; and
to supply the flow control device commands to the flow control device in response to the one or more additional signals.

16. A hydrodynamic gas film bearing cooling gas control system, comprising:
a hydrodynamic gas film bearing;
a first supply conduit in fluid communication with the hydrodynamic gas film bearing, the supply conduit coupled to receive a flow of cooling gas from a cooling gas supply source and configured to supply the flow of cooling gas to the hydrodynamic gas film bearing;
a first flow control device coupled to the first supply conduit and responsive to a physical characteristic of the cooling gas to move between at least two positions to thereby vary the flow of cooling gas, through the first supply conduit, to the hydrodynamic gas film bearing;
a second supply conduit in fluid communication with the hydrodynamic gas film bearing, the second supply conduit coupled to receive a flow of cooling gas from the cooling gas supply source and configured to supply the flow of cooling gas to the hydrodynamic gas film bearing; and
a second flow control device coupled to the second supply conduit and responsive to the physical characteristic of the cooling gas or ambient environment to move between at least two positions to thereby vary the flow of cooling gas, through the second supply conduit, to the hydrodynamic gas film bearing.

17. The system of claim 16, further comprising:
a third supply conduit in fluid communication with the hydrodynamic gas film bearing, the third supply conduit coupled to receive a flow of cooling gas from the cooling gas supply source and configured to supply the flow of cooling gas to the hydrodynamic gas film bearing.

18. A hydrodynamic gas film bearing cooling gas control system, comprising:
a hydrodynamic gas film bearing;
a supply conduit in fluid communication with the hydrodynamic gas film bearing, the supply conduit coupled to receive a flow of cooling gas from a cooling gas supply source and configured to supply the flow of cooling gas to the hydrodynamic gas film bearing;
a first flow control device coupled to the supply conduit and responsive to a physical characteristic of the cooling gas or ambient environment to move between at least two positions to thereby vary the flow of cooling gas, through the supply conduit, to the hydrodynamic gas film bearing;
a second flow control device coupled to the supply conduit and responsive to the physical characteristic of the cooling gas or ambient environment to move between at least two positions to thereby vary the flow of cooling gas, through the supply conduit, to the hydrodynamic gas film bearing.

19. The system of claim 18, further comprising:
a flow restriction disposed upstream of supply conduit, the flow restriction having a cross sectional flow area,
wherein cooling gas that flows through the flow restriction does so independent of the first flow control device and the second flow control device.

20. A hydrodynamic gas film bearing cooling gas control system, comprising:
a hydrodynamic gas film bearing;
a supply conduit in fluid communication with the hydrodynamic gas film bearing, the supply conduit coupled to receive a flow of cooling gas from a cooling gas supply source and configured to supply the flow of cooling gas to the hydrodynamic gas film bearing; and
a flow control device coupled to the supply conduit and responsive to a physical characteristic of the cooling gas or ambient environment to move between at least a first position and a second position;
a first flow restriction disposed between the flow control device and the supply conduit, the first flow restriction having a first cross sectional flow area; and
a second flow restriction disposed between the flow control device and the supply conduit, the second flow restriction having a second cross sectional flow area, the second cross sectional flow area greater than the first,
wherein:
the cooling gas flows through the first flow restriction at least when the flow control device is in the first position, and
the cooling gas flows through the second flow restriction at least when the flow control device is in the second position.
